(19) United States
(12) Patent Application Publication
(10) Pub. No.: US 2005/0217103 A1
(43) Pub. Date: Oct. 6, 2005

(54) Method for manufacturing a twisted handle and device for twisting the handle

(76) Inventor: Chih-Ching Hsien, Taichung (TW)

Correspondence Address: Mr. Phillip Liu, 6980 Whiteoak Dr., Richmond, BC, V7E 4Z9, CA

(21) Appl. No.: 10/815,777

(22) Filed: Apr. 2, 2004

(51) Int. Cl. A61C 5/02; B21B 1/46

(52) U.S. Cl. 29/527.2; 72/299

(57) ABSTRACT

A method for manufacturing a twisted handle of a hand tool includes a step of forging the handle, annealing the handle; machining the handle to have a full scale; polishing the handle; twisting the handle by a twisting device; secondary polishing the twisted area of the handle; proceeding a heat treatment to the handle; vibrating the handle to obtain a fine surface of the handle, and electroplating the handle. The twisting device includes a clamping unit to clamp an end of the handle and a rotating unit to hold the handle and rotate 90 degrees.

### FIELD OF THE INVENTION

The present invention relates to a method for twisting a handle of a hand tool and a device for proceeding the twisting the handle.

### BACKGROUND OF THE INVENTION

A conventional method for manufacturing a handle of a hand tool generally includes steps of forging, annealing, machining, polishing, vibrating and electroplating. The conventional method is designed to manufacture a handle that is a straight handle which includes two wide surfaces and two narrow surfaces. The wide surfaces are located parallel to the function ends such as the box end connected to an end of the handle. However, it is noted that when using the handle, the user's fingers are suffered by high pressure from the narrow surfaces, because the direction of rotation of the handle is perpendicular to the narrow surfaces. A twisted handle is developed that is twisted at an intermediate point so that the user's palm holds the wide surfaces when rotating the handle. The conventional method lacks of a step of twisting so that the percentage of defectiveness cannot be reduced.

The present invention intends to provide a method and device for manufacturing a twisted handle.

### SUMMARY OF THE INVENTION

The present invention relates to a method for manufacturing a twisted handle of a hand tool, and includes a step of forging a handle; a step of annealing the handle; a step of machining the handle to have a full scale; a step of polishing the handle in step 3; a step of twisting the handle in step 4 to include two sections which are connected co-axially and oriented by an angle of 90 degrees; a step of secondary polishing a twisted area of the handle in step 5; a step of proceeding a heat treatment to the handle in step 6; a step of vibrating the handle in step 7 to obtain a fine surface of the handle, and a step of electroplating the handle in step 8.

The device for twisting the handle includes a clamping unit for clamping an end of the handle and a rotating unit for holding the handle. The holding unit includes a holding member having a slot so as to receive the handle, and a positioning member extending in the holding member and contacts the handle. A driving unit has a shaft which is connected to the holding member which is rotated by the driving unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the twisting device of the present invention;

FIG. 2 shows that the holding member is rotated to twist the handle;

FIG. 3 is an end cross sectional view to show the handle is held by the holding member;

FIG. 4 is an end cross sectional view to show the handle is twisted by the holding member;

FIG. 5 shows the twisted handle made by the twisted device of the present invention, and

FIG. 6 shows a side view of the twisted handle made by the twisted device of the present invention.

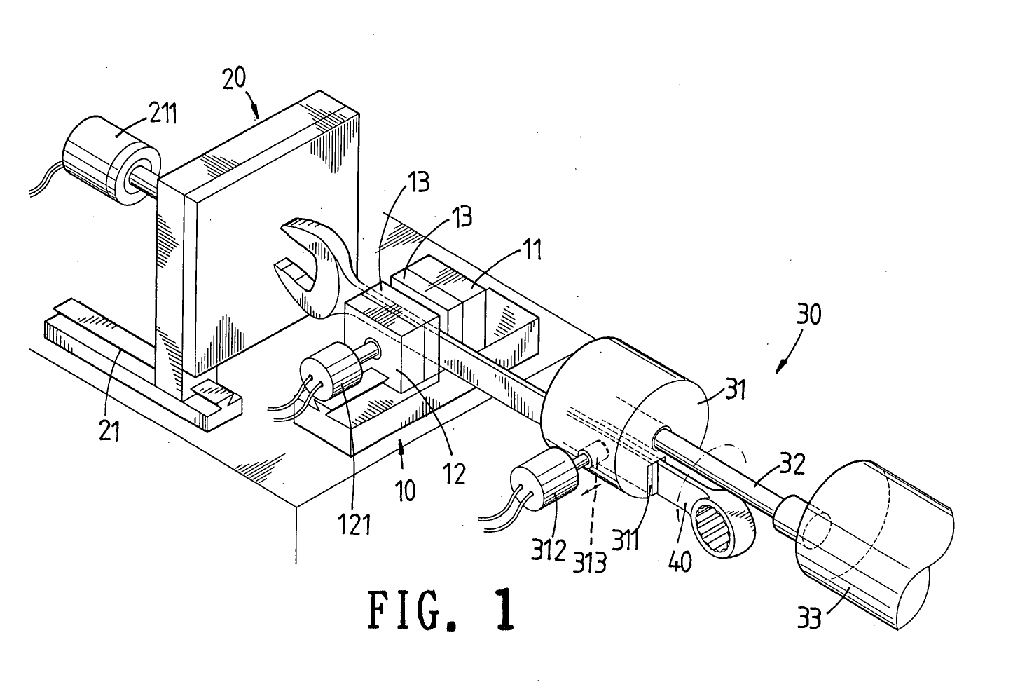

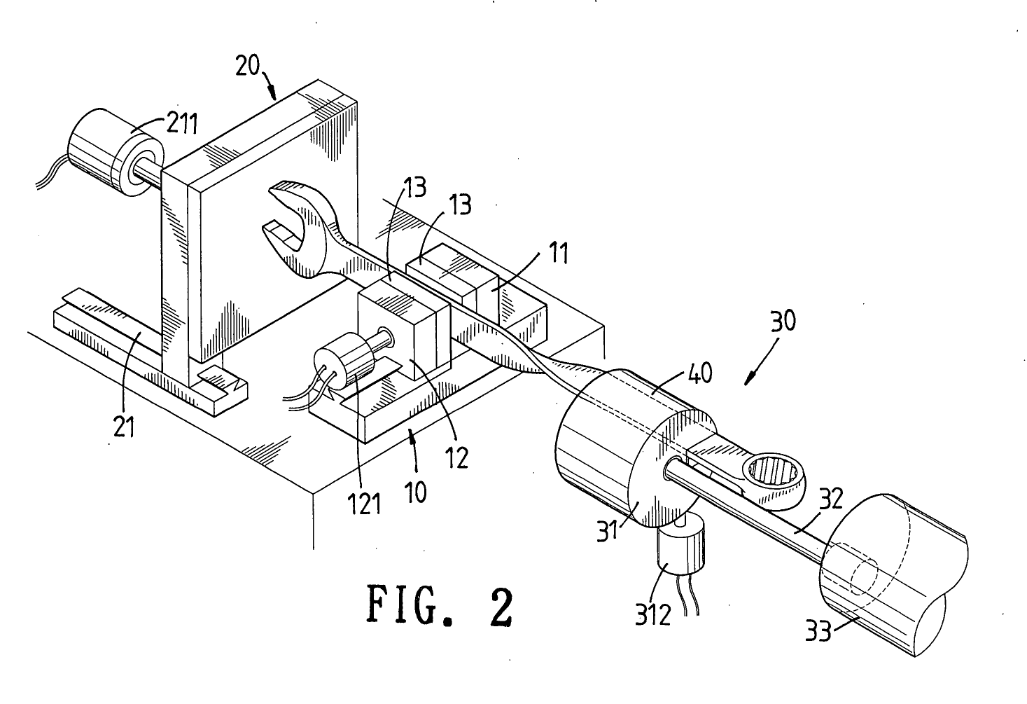

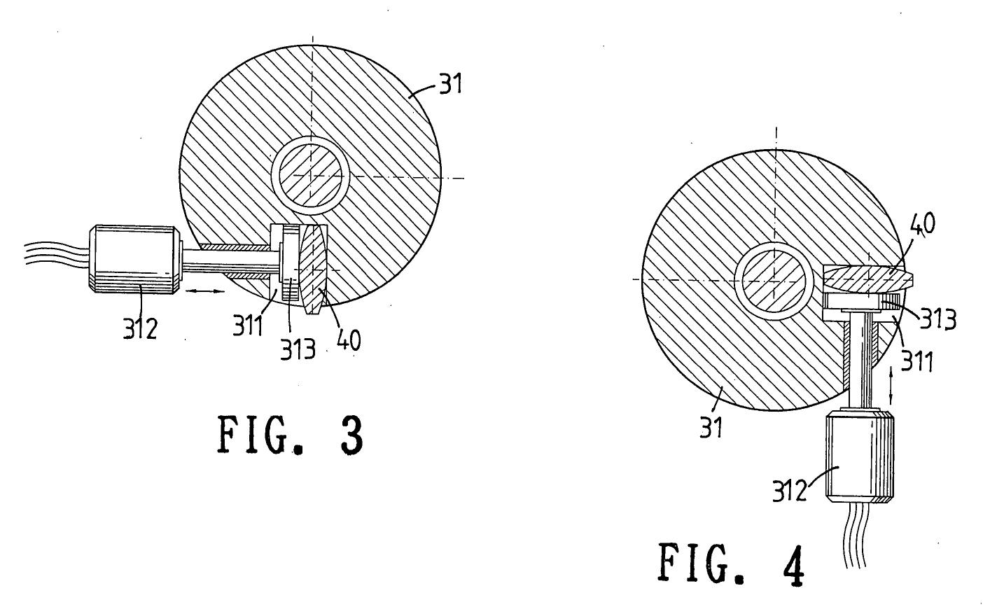

### DETAILED DESCRIPTION OF THE PREFERRED EMBODIMENT

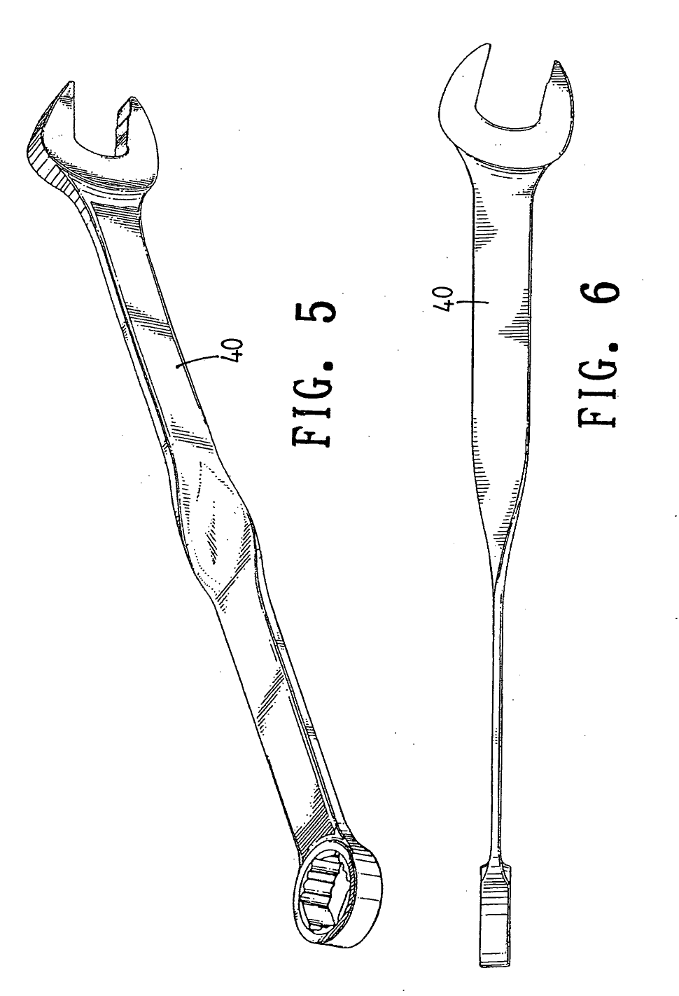

The method for manufacturing a twisted handle 40 of a hand tool as shown in FIGS. 5 and 6 includes the following steps:
step 1: forging a handle;
step 2: annealing the handle;
step 3: machining the handle to have a full scale;
step 4: polishing the handle in step 3;
step 5: twisting the handle in step 4 to include two sections which are connected co-axially, the two sections being oriented by an angle of 90 degrees;
step 6: secondary polishing a twisted area of the handle in step 5;
step 7: proceeding a heat treatment to the handle in step 6;
step 8: vibrating the handle in step 7 to obtain a fine surface of the handle, and
step 9: electroplating the handle in step 8.

Step 3 of the method may include a process by putting the handle in a rotating bucket and small particles in the bucket impact the surface of the handle so as to remove surplus or a layer of carbon. The handle is then machined to be stretched to have the full scale.

The twisting device for manufacturing the twisted handle 40 comprises a clamping unit 10 which comprises a fixed jaw 11 and a movable jaw 12 which is moved by a first hydraulic cylinder 121. Each of the fixed jaw 11 and the movable jaw 12 has a pad 13 to prevent from damaging the handle 40 that is clamped between the fixed jaw 11 and the movable jaw 12. A rotating unit 30 comprises a holding member 31 having a slot 311 defined therein and the handle 40 is received in the slot 311. A positioning member 313 extends in the holding member 31 and contacts the handle 40. The positioning member 313 is connected to a second hydraulic cylinder 312. A driving unit 33 has a shaft 32 which is connected to the holding member 31 and the shaft 32 is rotated by the driving unit 33. A stop member 20 is located beside the clamping unit 10 and contacts an end of the handle 40. It is noted that the stop member 20 is movably connected to two rails 21 and connected to a hydraulic cylinder 211. The stop member 20 is moved on the two rails 21 so that the different lengths of handles 40 can be used.

While we have shown and described the embodiment in accordance with the present invention, it should be clear to those skilled in the art that further embodiments may be made without departing from the scope of the present invention.

1. A method for manufacturing a twisted handle of a hand tool, comprising:
step 1: forging a handle;
step 2: annealing the handle;
step 3: machining the handle to have a full scale;
step 4: polishing the handle in step 3;
step 5: twisting the handle in step 4 to include two sections which are connected co-axially, the two sections being oriented by an angle of 90 degrees;
step 6: secondary polishing a twisted area of the handle in step 5;
step 7: proceeding a heat treatment to the handle in step 6;
step 8: vibrating the handle in step 7 to obtain a fine surface of the handle, and
step 9: electroplating the handle in step 8.

2. A device for twisting a handle of a hand tool, comprising:
a clamping unit comprising a fixed jaw and a movable jaw;
a rotating unit comprising a holding member having a slot defined therein so as to be adapted to receive the handle in the slot, a positioning member extending in the holding member and adapted to contact the handle, and
a driving unit having a shaft which is connected to the holding member and the shaft rotated by the driving unit.

3. The device as claimed in claim 2 further comprising a stop member located beside the clamping unit and adapted to contact an end of the handle.

4. The device as claimed in claim 3, wherein the stop member is movably connected to two rails and connected to a hydraulic cylinder.
